(19) United States
(12) Patent Application Publication
(10) Pub. No.: US 2009/0012706 A1
(43) Pub. Date: Jan. 8, 2009

(54) SYSTEM AND METHOD FOR PROVIDING A TRAVEL INFORMATION USING A PERSONAL PORTABLE TERMINAL

(75) Inventor: Sang Bae Kim, Seoul (KR)

Correspondence Address: RABIN & Berdo, PC, 1101 14TH STREET, NW, SUITE 500, WASHINGTON, DC, 20005, US

(73) Assignee: CYBERTEK HOLDINGS, INC., SEOUL (KR)

(21) Appl. No.: 12/097,202

(22) PCT Filed: Oct. 22, 2007
(86) PCT No.: PCT/KR2007/005167

§ 371 Date: Jun. 12, 2008

(30) Foreign Application Priority Data
Oct. 23, 2006 (KR) 10-2006-0102986

(51) Int. Cl. G01C 21/00

(52) U.S. Cl. 701/201; 701/213; 701/208

(57) ABSTRACT

The present invention relates to a travel guide system using a personal portable terminal, and more particularly, a travel guide system using a personal portable terminal including: an integrated circuit (IC) chip attached to each of a plurality of stores, the IC chip including an identification code peculiar to each store; and the personal portable terminal receiving a signal from a plurality of global positioning system (GPS) satellites and showing a present position thereof, the personal portable terminal providing detail information about each store mapped to the identification code obtained through a near field communication with the IC chip.

### TECHNICAL FIELD

The present invention relates to a system and a method for providing travel information to foreigner unfamiliar with geography and language, and more particularly, to a travel system, a travel guide device and a travel guide method for providing travel guide information using a personal portable terminal that provide a position information through a wireless communication means.

### BACKGROUND ART

Recently, foreign travelers have increased due to active exchange between nations. However, the foreign travelers use package goods provided by a traveler agency or visit extremely limited famous places because of inconvenience in language.

In general, the travelers including foreigners may purchase a travel guide book as an off-line means or use a web site such as a homepage of a traveler agency and a map service for obtaining information about the destination.

However, the travel guide book includes location information only of famous travel places, great buildings or great accommodations because the travel guide book has a limited space. In addition, when the travelers use the web site, the travelers can obtain information only about several famous amenities from the homepage or only road information from the map service. Further, it is difficult to read the road information because of restriction of image files.

More recently, a computer and an internet, which are a media of transmitting information, have been introduced as an essential tool for a new communication, and information about travel and travel may be obtained through the internet.

However, since the travel information provided by a web site is not fitted information to a private individual but common information provided to the general public contacting the web site. Accordingly, the travelers note down or print out necessary information based on their own travel schedule, and carry a paper having the necessary information during the travel.

Specifically, foreign travelers have limited circumstances because of different language. As a result, the foreign travelers use only package goods of a traveler agency having a local guide or have a limited travel only through a local acquaintance.

Therefore, a method that foreign travelers can travel conveniently and easily find out a destination for themselves is required.

### DISCLOSURE

### Technical Problem

Accordingly, an object of the present invention is to provide a travel guide system, a travel guide device and a travel guide method using a personal portable terminal that provides a map regarding to a present position through a GPS (global positioning system), and travel information about an adjacent area to the present position.

In addition, another object of the present invention is to a travel guide system, a travel guide device and a travel guide method using a personal portable terminal that provides information about an adjacent store by communicating with an IC (integrated circuit) chip attached to the adjacent store through a near field communication.

Furthermore, another object of the present invention is to a travel guide system, a travel guide device and a travel guide method using a personal portable terminal that provides a map regarding a present position through a GPS, and location and detail information about a registered store adjacent to the present position.

### Technical Solution

To achieve these and other advantages and in accordance with the purpose of embodiments of the invention, as embodied and broadly described, a travel guide system using a personal portable terminal includes: an integrated circuit (IC) chip attached to each of a plurality of stores, the IC chip including an identification code peculiar to each store; and the personal portable terminal receiving a signal from a plurality of global positioning system (GPS) satellites and showing a present position thereof, the personal portable terminal providing detail information about each store mapped to the identification code obtained through a near field communication with the IC chip.

In another aspect, a travel guide device using a personal portable terminal includes: a global positioning system (GPS) receiving unit receiving a signal from a plurality of GPS satellites and calculating a present position; a near field wireless processing unit communicating with an integrated circuit (IC) chip attached to each of a plurality of stores, the IC chip including an identification code peculiar to each store; and a control unit performed for showing the present position in a map by receiving the signal from the plurality of GPS satellites and for providing a detail information about each store mapped to the identification code obtained through a near field communication with the IC chip.

In another aspect, a travel guide method using a personal portable terminal includes: calculating a present position of the personal portable terminal by receiving a signal from a global positioning system (GPS) satellite and showing the present position in a map; searching a plurality of stores having a integrated circuit (IC) chip within a predetermined distance from the present position and showing the searched stores in the map; recognizing the IC chip attached to a corresponding store through a near field communication with the IC chip when the personal portable terminal approaches the corresponding store; and outputting a detail information about the corresponding store mapped to an identification code peculiar to the corresponding store in a predetermined language according to a result of the recognizing.

The travel guide method according to an embodiment of the present invention may be stored in a record media readable by a server computer. The record media includes all kinds of media storing programs and data so that a computer system can read the media. Examples of the record media include read only memory (ROM), random access memory (RAM), compact disk (CD), digital video disk (DVD)-ROM, magnetic tape, floppy disk, optical data storage device, and carrier wave (e.g. transmission through internet). In addition, the record media is spread in a computer system connected through a network, and computer readable codes of the record media are stored and executed through a spread method.

### ADVANTAGEOUS EFFECTS

According to the present invention, a foreign traveler effectively obtains detail information about neighboring travel and geography even when the foreign traveler does not know a language of the corresponding nation.

In addition, the foreign traveler easily find out a store adjacent to a position of the foreign traveler and information about the store is efficiently provided to the foreign traveler through a personal portable terminal.

### DESCRIPTION OF DRAWINGS

The accompanying drawings, which are included to provide a further understanding of embodiments of the invention and are incorporated in and constitute a part of this specification, illustrate embodiments of the invention and together with the description serve to explain the principles of embodiments of the invention. In the drawings:

FIG. 1 is a view showing a travel guide system using a personal portable terminal according to an embodiment of the present invention.

FIG. 2 is a block diagram showing a personal portable terminal according to an embodiment of the present invention.

FIG. 3 is a block diagram showing a travel guide device according to an embodiment of the present invention.

FIG. 4 is a view showing a structure of a message by an IC chip according to an embodiment of the present invention.

FIG. 5 is a flow chart showing a travel guide method using a personal portable terminal according to an embodiment of the present invention.

FIG. 6 is a view showing an image displayed in a personal portable terminal according to an embodiment of the present invention.

<Illustration Of Reference Numbers For Principal Parts Of Drawings>

| | | | |
|---|---|---|---|
| 100: | GPS satellite | 110: | personal portable terminal |
| 120: | IC card | 210: | input unit |
| 220: | GPS receiving unit | 230: | control unit |
| 240: | near field wireless | 260: | displaying unit |
| | processing unit | 252: | map information database |
| 250: | storage unit | 254: | store information database |
| 251: | application program | 310: | position judging unit |
| 253: | code information database | 330: | code analyzing unit |
| 300: | travel guide device | 402: | store identification code |
| 320: | position displaying unit | | region |
| 340: | code information | 404: | CRC region |
| | searching unit | | |
| 350: | store information | | |
| | outputting unit | | |
| 401: | preamble region | | |
| 403: | auxiliary region | | |

### BEST MODE

Reference will now be made in detail to the illustrated embodiments of the invention, examples of which are illustrated in the accompanying drawings. However, the illustrated embodiments may be modified into various different embodiments and the scope of the invention should not be interpreted to be limited to the illustrated embodiments. The illustrated embodiments of the invention are provided to illustrate the invention to those skilled in the art more completely.

When a person such as a foreigner unfamiliar with geographical information makes a travel, geographical information based on the present position is provided in the person's language, and detail information about a store (or a building) adjacent to the present position is provided in the person's language through a personal portable terminal according to the present invention.

Here, a global positioning system (GPS) is used for detecting the present position, and a detail map regarding an adjacent area of the present position is provided through the personal portable terminal according to the present invention.

In addition, locations of registered stores whose detail information is registered among stores (or buildings) within a predetermined distance from the present position are shown in the detail map. When a user of the personal portable terminal selects one of the registered stores shown in the detail map, the saved detail information of the selected store is provided in a predetermined language or a path to the selected store is provided in the detail map.

Furthermore, the personal portable terminal communicates with an integrated circuit (IC) chip attached to entrances to the registered stores through a near field communication (NFC). As a result, when the user of the personal portable terminal approaches the registered stores to be in a specific distance from the registered stores, the personal portable terminal receives identification information peculiar to the corresponding store from the corresponding IC chip, and searches and provides the saved detail information of the corresponding store mapped to the identification information.

Accordingly, a foreign traveler makes an effective travel by obtaining information about a store adjacent to his present position in his own language even when the foreign traveler does not know a language and a geography of the nation for travel.

The personal portable terminal may be achieved as one of a portable multimedia player (PMP), a personal digital assistant (PDA), a mobile phone and a notebook by adding functions according to the present invention. More effectively, the personal portable terminal may be achieved as a PMP because the PMP has portability and can store a large amount of information such as map information and detail information of a store.

When a foreigner visits and makes a travel through a nation, the foreigner can obtain services according to the present invention by temporarily renting and setting in his own language a personal portable terminal having functions of GPS receiving and near field communication and storing detail information about registered stores.

To achieve the present invention, the personal portable terminal preferably includes a GPS receiving module and a near field communication means. In addition, the personal portable terminal stores a map data for showing the present position calculated by the GPS receiving module and stores detail information such as a text or an image about the stores (or the buildings) mapped to the identification code from the IC chip.

Hereinafter, a system according to the present is illustrated referring to FIG. 1.

FIG. 1 is a view showing a travel guide system using a personal portable terminal according to an embodiment of the present invention.

As shown in FIG. 1, a system according to the present invention includes a GPS satellite 100, a personal portable terminal 110 and an IC chip 120. The personal portable terminal 110 receives a signal from a GPS satellite 100, and obtains the present position of the personal portable terminal 110 using the signal. Further, the personal portable terminal 110 stores a map data, and displays map information including the present position as a reference.

The personal portable terminal 110 communicates with an IC chip 120 attached to each store through a near field communication, for example, a infrared data association (IrDA), a Bluetooth, a wireless local area network (LAN), a ZigBee, a ultra wideband (UWB) and a low power radio frequency (RF). An identification code peculiar to each store is stored in the IC chip 120, and the personal portable terminal 110 reads the identification information in the IC chip 120 through the near field communication. Accordingly, when the personal portable terminal 110 approaches the IC chip 120 to be in a near field communication area, the personal portable terminal 110 automatically provides saved detail information of each store mapped to the identification code read from the IC chip 120.

The personal portable terminal 110 provides a list or locations of the stores having the IC chip 120 within a predetermined distance from the present position recognized using the GPS satellite 100. As a result, the detail information of the corresponding store or a path to the corresponding store from the present position is provided to a user of the personal portable terminal 110 by selecting one of the stores within the predetermined distance. For example, the detail information of the corresponding store may include a text or an image in a language that the user of the personal portable terminal 110 selects.

Accordingly, the information of the present position is provided to the user of the personal portable terminal 110, and the detail information or the location information of the registered stores adjacent to the present position is provided to the user. When the user approaches one of the registered stores, the personal portable terminal 110 provides the detail information about the corresponding store in a selected language to the user.

For example, when a French visits in an unfamiliar place of Korea, to find out a famous French restaurant nearest from the present position of the French, the French may search the French restaurant located at the nearest distance from the present position and follow the path to the French restaurant. Alternatively, the French may verify detail information about the registered restaurants adjacent to the present position and select one of the restaurants.

In addition, when the French passes the restaurant having the IC chip 120, the French may obtain the detail information about the corresponding restaurant in his language, i.e., French, from the personal portable terminal 110 without entering the corresponding restaurant. As a result, the problems of a foreign traveler in language for finding out the destination are solved with ease.

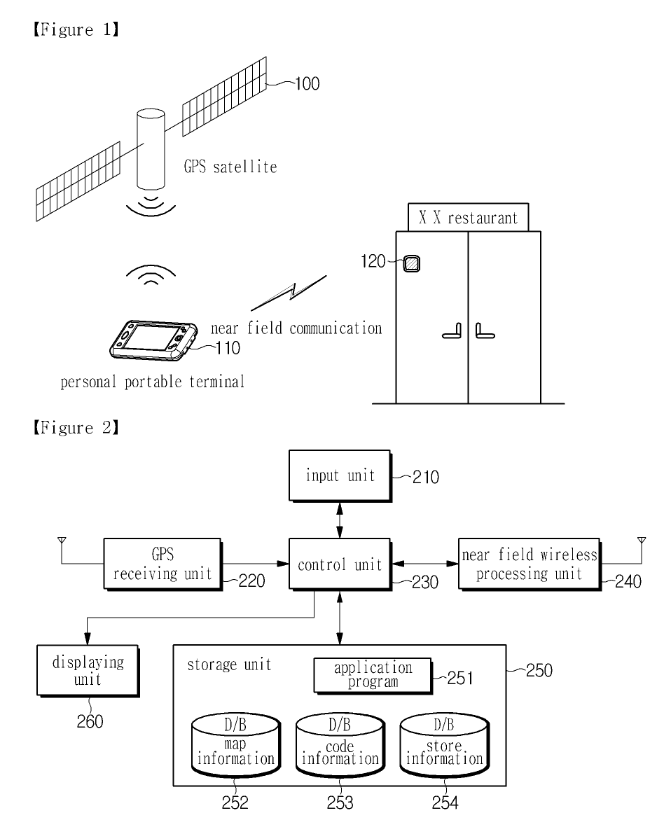

FIG. 2 is a block diagram showing a personal portable terminal according to an embodiment of the present invention.

As shown in FIG. 2, a personal portable terminal 110 includes an input unit 210, a GPS receiving unit 220, a control unit 230, a near field wireless processing unit 240, a storage unit 250 and a displaying unit 260. In addition, an application program 251 for providing various services according to the present invention and a database regarding information for the various services are stored in the storage unit 250. For example, a map information database 252, a code information database 253 and a store information database 254 may be stored in the storage unit 250.

The input unit 210 is used as a means for executing programs of the personal portable terminal 110, or for selecting or inputting information. For example, the input unit 210 may include one of a keypad and a touch screen. Further, the displaying unit 260 such as a liquid crystal display (LCD) displays a map information or a store information according to the present invention.

The GPS receiving unit 220 receives a signal from the GPS satellite and calculates the present position through a predetermined operation. Moreover, the near field wireless processing unit 240 communicates with the IC chip attached to each store and receives an identification code peculiar to each store from the IC chip.

The application program 251 in the storage unit 250 is executed by an execution instruction of the user, and the various services according to the present invention are provided. Accordingly, the present position is calculated using the signal that the GPS receiving unit 220 receives, and the map information corresponding to a coordinate of the present position is provided through the map information database 252. Furthermore, the code information about the registered stores within a predetermined distance from the present position is read from the code information database 253 and is shown in the map information. When the user selects one store from the code information about registered stores shown in the map information or selects one store among the registered stores through a search, the detail information about the selected store mapped to the corresponding identification code is read from the store information database 254 and displayed.

The near field wireless processing unit 240 receives the identification code peculiar to the corresponding store by communicating with the IC chip attached to the corresponding store, and the code information corresponding to the identification code is read from the code information database 253. In addition, the detail information about the corresponding store mapped to the code information is read from the store information database 254 and is displayed.

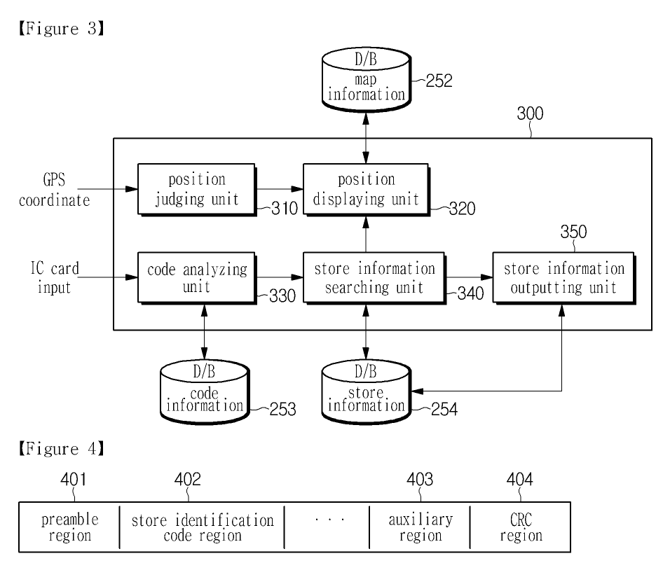

FIG. 3 is a block diagram showing a travel guide device according to an embodiment of the present invention. Various functions according to the present invention may be provided by a hardware device as shown in FIG. 3 or may be provided by a software program as shown in FIG. 2. Regardless of embodiments, the same functions are provided.

As shown in FIG. 3, a travel guide device 300 includes a position judging unit 310, a position displaying unit 320, a code analyzing unit 330, a store information searching unit 340 and a store information outputting unit 350.

The position judging unit 310 judges the present position using the GPS coordinate and the position displaying unit 320 reads and outputs the map information regarding the present position of the position judging unit 310 in the map information database 252.

The code analyzing unit 330 analyzes an input by the IC chip (or the IC card) attached to each store to detect the identification code peculiar to each store. Further, the code analyzing unit 330 verifies a real store mapped to the detected identification code referring to the code information database 253. Next, the store information searching unit 340 reads the detail information about the verified store in the store information database 254.

The location information of the read detail information about the verified store is transmitted to the position displaying unit 320 to be displayed in the map information, and the other detail information about the verified store is displayed through the store information outputting unit 350.

FIG. 4 is a view showing a structure of a message by an IC chip according to an embodiment of the present invention.

As shown in FIG. 4, the message outputted from the IC card (or the IC chip) attached to each store includes a preamble region 401, a store identification code region 402 peculiar to each store, an auxiliary region 403 and a cyclic redundancy check (CRC) region 404.

The preamble region 401 is used as a header for sensing the corresponding radio frequency (RF) signal among various transmitted RF signals, and the store identification code region 402 includes the identification code peculiarly assigned to each store having the IC chip.

The auxiliary region 403 is a data area for a subsequent additional information, and the CRC region 404 stores residual bits added for checking errors of the message transmitted through a wireless channel.

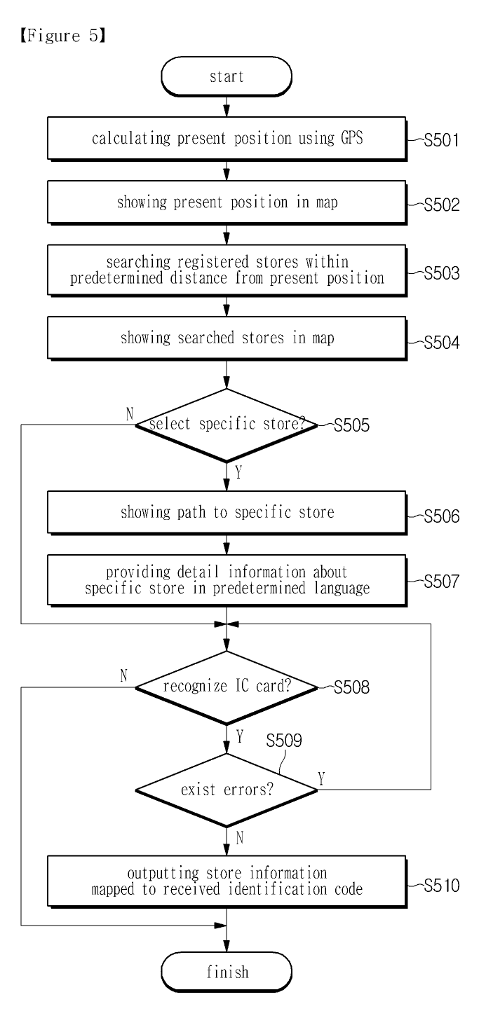

FIG. 5 is a flow chart showing a travel guide method using a personal portable terminal according to an embodiment of the present invention.

As shown in FIG. 5, the present position of the personal portable terminal is calculated using the GPS (S501). The present position is shown in a map according to the positioning (S502).

Next, the registered stores, i.e., the stores having the IC chip, within a predetermined distance from the present position are searched (S503), and the searched stores are shown in the map (S504).

Here, the user selects a specific store of the shown stores or a specific store of the searched stores (S505). The path to the specific store is shown in the map (S506), or the detail information about the specific store is provided in a predetermined language (S507).

When the user approaches the specific store along the path, or when the user of the personal portable terminal approaches one of registered stores, the personal portable terminal recognizes the IC card (or IC chip) through the near field communication with the IC card (or IC chip) attached to the corresponding store (S508). When the recognition result is normal without errors (S509), the store information mapped to the received identification code peculiar to each store is outputted in the predetermined language (S510).

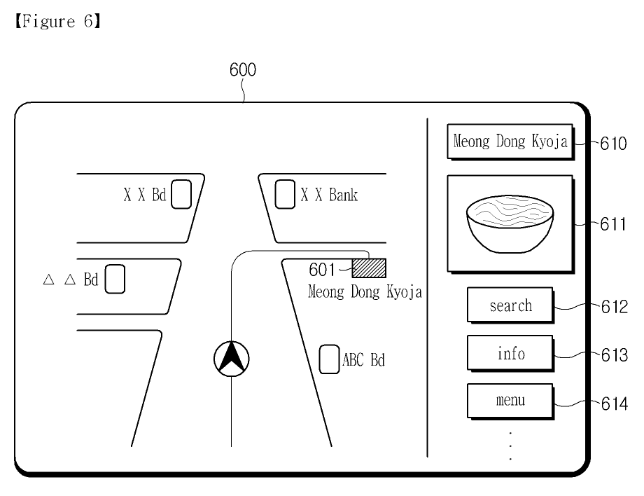

FIG. 6 is a view showing an image displayed in a personal portable terminal according to an embodiment of the present invention.

As shown in FIG. 6, a personal portable terminal provides a detail map 600 showing areas adjacent to the present position of a user. When a registered store (601) having an IC chip is selected, a path to the selected store 601 is shown in the detail map 600. Further, the detail information about the selected store 601 such as a store name 610, a store image 611, a search 612, a detail information 613 and a menu 614 is shown in the detail map 600.

Moreover, although not shown in FIG. 6, various kinds of stores adjacent to the present position are searched and outputted, and the detail information about the corresponding stores is provided in the predetermined language when the personal portable terminal can communicate with the corresponding stores through the near field communication.

It will be apparent to those skilled in the art that various modifications and variations can be made in the travel guide system, device and method using a personal portable terminal of embodiments of the invention without departing from the spirit or scope of the invention. Thus, it is intended that embodiments of the invention cover the modifications and variations of this invention provided they come within the scope of the appended claims and their equivalents.

1. A travel guide system using a personal portable terminal, comprising:
an integrated circuit (IC) chip attached to each of a plurality of stores, the IC chip including an identification code peculiar to each store; and
the personal portable terminal receiving a signal from a plurality of global positioning system (GPS) satellites and showing a present position thereof, the personal portable terminal providing detail information about each store mapped to the identification code obtained through a near field communication with the IC chip.

2. The travel guide system according to claim 1, wherein the near field communication includes one of a infrared data association (IrDA), a Bluetooth, a wireless local area network (LAN), a ZigBee, a ultra wideband (UWB) and a low power radio frequency (RF).

3. The travel guide system according to claim 1, wherein the personal portable terminal provides the detail information about each store having the IC chip within a predetermined distance from the present position.

4. The travel guide system according to claim 1, wherein the personal portable terminal provides the detail information about each store having the IC chip satisfying a search condition through a search.

5. The travel guide system according to claim 3, wherein the detail information about a selected store among the plurality of stores is provided in a predetermined language.

6. The travel guide system according to claim 5, wherein the detail information includes a path from the present position to the selected store.

7. The travel guide system according to claim 5, wherein the detail information includes an information about the selected store comprising at least one of a text, an image and a sound.

8. The travel guide system according to claim 1, wherein when the personal portable terminal approaches and communicates with the IC chip through the near field communication, the personal portable terminal verifies the identification code of the IC chip and automatically outputs the detail information about each store mapped to the identification code.

9. A travel guide device using a personal portable terminal, comprising:
a global positioning system (GPS) receiving unit receiving a signal from a plurality of GPS satellites and calculating a present position;
a near field wireless processing unit communicating with an integrated circuit (IC) chip attached to each of a plurality of stores, the IC chip including an identification code peculiar to each store; and
a control unit performed for showing the present position in a map by receiving the signal from the plurality of GPS satellites and for providing a detail information about each store mapped to the identification code obtained through a near field communication with the IC chip.

10. The travel guide device according to claim 9, further comprising an application program executed for the control unit to provide the detail information, and a storage unit storing a plurality of databases for proving the detail information.

11. The travel guide device according to claim 10, wherein the storage unit includes a map information database having a map information corresponding to a coordinate.

12. The travel guide device according to claim 10, wherein the storage unit includes a code information database having the identification code peculiar to each store and a store information mapped to the identification code.

13. The travel guide device according to claim 10, wherein the storage unit includes a store information database having the detail information about each store having the IC chip.

14. The travel guide device according to claim 9, wherein the near field communication includes one of a infrared data association (IrDA), a Bluetooth, a wireless local area network (LAN), a ZigBee, a ultra wideband (UWB) and a low power radio frequency (RF).

15. The travel guide device according to claim 9, wherein the device provides the detail information about each store having the IC chip within a predetermined distance from the present position.

16. The travel guide device according to claim 9, wherein the device provides the detail information about each store having the IC chip satisfying a search condition through a search.

17. The travel guide device according to claim 15, wherein the detail information about a selected store among the plurality of stores is provided in a predetermined language.

18. The travel guide device according to claim 17, wherein the detail information includes a path from the present position to the selected store.

19. The travel guide device according to claim 17, wherein the detail information includes an information about the selected store comprising at least one of a text, an image and a sound.

20. The travel guide device according to claim 9, wherein when the personal portable terminal approaches and communicates with the IC chip through the near field communication, the device verifies the identification code of the IC chip and automatically outputs the detail information about each store mapped to the identification code.

21. A travel guide method using a personal portable terminal, comprising:
calculating a present position of the personal portable terminal by receiving a signal from a global positioning system (GPS) satellite and showing the present position in a map;
searching a plurality of stores having a integrated circuit (IC) chip within a predetermined distance from the present position and showing the searched stores in the map;
recognizing the IC chip attached to a corresponding store through a near field communication with the IC chip when the personal portable terminal approaches the corresponding store; and
outputting a detail information about the corresponding store mapped to an identification code peculiar to the corresponding store in a predetermined language according to a result of the recognizing.

22. The travel guide method according to claim 21, further comprising showing a path to a selected store among the plurality of stores in the map.

23. The travel guide method according to claim 21, wherein the near field communication includes one of a infrared data association (IrDA), a Bluetooth, a wireless local area network (LAN), a ZigBee, a ultra wideband (UWB) and a low power radio frequency (RF).

24. The travel guide method according to claim 21, wherein the personal portable terminal provides the detail information about each store having the IC chip within a predetermined distance from the present position.

25. The travel guide method according to claim 21, wherein the personal portable terminal provides the detail information about each store having the IC chip satisfying a search condition through a search.

26. The travel guide method according to claim 21, wherein the detail information includes an information about the corresponding store comprising at least one of a text, an image and a sound.

27. The travel guide method according to claim 21, wherein when the personal portable terminal approaches and communicates with the IC chip through the near field communication, the personal portable terminal verifies the identification code of the IC chip and automatically outputs the detail information about each store mapped to the identification code.
